(19) United States
(12) Patent Application Publication
(10) Pub. No.: US 2025/0189740 A1
(43) Pub. Date: Jun. 12, 2025

(54) IMAGING COUPLERS FOR MICROLED LINKS

(71) Applicants: Robert Kalman, Sunnyvale, CA (US); Howard Rourke, Sunnyvale, CA (US)

(72) Inventors: Robert Kalman, Sunnyvale, CA (US); Howard Rourke, Sunnyvale, CA (US)

(21) Appl. No.: 18/973,760

(22) Filed: Dec. 9, 2024

Related U.S. Application Data
(60) Provisional application No. 63/607,790, filed on Dec. 8, 2023.

(51) Int. Cl. G02B 6/43; G02B 6/42

(52) U.S. Cl. CPC G02B 6/43; G02B 6/4214

(57) ABSTRACT

A microLED-based optical interconnect may include an optical coupling assembly having a first optical coupling subassembly and a second optical coupling subassembly, which may be coupled together. The first optical coupling subassembly may interface to an IC having an array of optoelectronics devices on its surface. The second optical coupling assembly may receive an end of a fiber optic bundle. Both the first optical coupling subassembly and the second optical coupling subassembly may include optical elements in an optical path between the array of optoelectronic devices and the end of the fiber optic bundle. The optoelectronic devices may be microLEDs or photodetectors.

### CROSS-REFERENCE TO RELATED APPLICATIONS

This application claims the benefit of U.S. Provisional Patent Application No. 63/607,790, filed on Dec. 8, 2023, the disclosure of which is incorporated by reference herein.

### BACKGROUND OF THE INVENTION

The desire for high-performance computing and networking is ubiquitous and seemingly ever-present. Prominent applications include data center servers, high-performance computing clusters, artificial neural networks, and network switches.

For decades, dramatic integrated circuit (IC) performance and cost improvements were driven by shrinking transistor dimensions combined with increasing die sizes, summarized in the famous Moore's Law. Transistor counts in the billions have allowed consolidation onto a single system-on-a-chip (SoC) of functionality that was previously fragmented across multiple ICs. However, the benefits of further transistor shrinks are decreasing dramatically as decreasing marginal performance benefits combined with decreased yields and increased per transistor costs. Independent of these limitations, a single IC can only contain so much functionality, and that functionality is constrained because the IC's process cannot be simultaneously optimized for different functionality, for example logic requires a different process than memory and high speed I/O.

### BRIEF SUMMARY OF THE INVENTION

Some embodiments provide a microLED-based optical interconnect including an optical coupling assembly, comprising: a first array of optoelectronic devices on an integrated circuit (IC); a first fiber optic bundle comprised of multiple fiber elements, with a first face for coupling light into or out of the fiber elements at a first end of the first fiber optic bundle and a second face for coupling light into or out of the fiber elements at a second end of the first fiber optic bundle; a first optical coupling subassembly on the IC, the first optical coupling assembly including at least one first optical element positioned in an optical path of light between the first array of optoelectronic devices and the first face of the first fiber optic bundle; and a second optical coupling subassembly coupled to an end of the first optical coupling subassembly distal from the IC and coupled to the fiber optic bundle, the second optical subassembly including at least one second optical element positioned in the optical path of light between the first array of optoelectronic devices and the first face of the first fiber optic bundle.

In some embodiments the first optical coupling subassembly and/or the second optical coupling subassembly includes at least one recess for receiving the other optical coupling subassembly.

In some embodiments the first array of optoelectronic devices comprises an array of microLEDs. In some embodiments the first array of optoelectronic devices comprises an array of photodetectors. In some embodiments the at least one first optical element comprises a first lens. In some embodiments the at least one second optical element comprises a second lens. In some embodiments the at least one second optical element comprises a first mirror and second lens. In some embodiments the second optical coupling subassembly further includes a recess for receiving the first fiber optic bundle.

Some embodiments further comprise: a second array of optoelectronic devices on the integrated circuit (IC); a second fiber optic bundle comprised of multiple fiber elements, with a first face for coupling light into or out of the fiber elements at a first end of the second fiber optic bundle and a second face for coupling light into or out of the fiber elements at a second end of the second fiber optic bundle; a third optical coupling subassembly on the IC, the third optical coupling assembly including at least one third optical element positioned in an optical path of light between the second array of optoelectronic devices and the first face of the second fiber optic bundle; and a fourth optical coupling subassembly coupled to an end of the third optical coupling subassembly distal from the IC and coupled to the second fiber optic bundle, the fourth optical subassembly including at least one fourth optical element positioned in the optical path of light between the second array of optoelectronic devices and the first face of the second fiber optic bundle;

In some embodiments the third optical coupling subassembly and/or the fourth optical coupling subassembly include at least one recess for receiving the other optical coupling subassembly.

In some embodiments the first array of optoelectronic devices comprises an array of microLEDs and the second array of optoelectronic devices comprises an array of photodetectors. In some embodiments the at least one third optical element comprises a third lens. In some embodiments the at least one fourth optical element comprises a fourth lens. In some embodiments the at least one fourth optical element comprises a second mirror and fourth lens. In some embodiments the fourth optical coupling subassembly further includes a recess for receiving the second fiber optic bundle.

These and other aspects of the invention are more fully comprehended upon review of this disclosure.

### BRIEF DESCRIPTION OF THE FIGURES

FIG. 1 is a block diagram of a parallel optical interconnect.

FIGS. 2A-D illustrate cross-sectional views of examples of microlenses to be interposed between optical emitters or photodetectors and an optical coupling assembly.

FIGS. 3A-B illustrate cross-sectional views of optical coupling assemblies including lenses.

FIGS. 4A-B illustrate cross-sectional views of optical coupling assemblies including reflective surfaces.

FIGS. 5A-C illustrate cross-sectional views of optical coupling assemblies including optical coupling subassemblies.

FIGS. 6A-B illustrate cross-sectional views of further optical coupling assemblies including optical coupling subassemblies.

FIG. 7 illustrates a cross-sectional view of an optical coupling assembly comprising separate optical components and optomechanical structures.

FIGS. 8A-B illustrate cross-sectional views of arrays of optical coupling assemblies

interfaced to an IC.

FIG. 9 illustrates a cross-sectional view of an optical coupling assembly comprised of four optical coupling subassembly (OCSA) stages.

### DETAILED DESCRIPTION

There may be significant benefits to “de-integrating” SoCs into smaller “chiplets,” including: (1) the process for each chiplet can be optimized to its function; (2) chiplets are well-suited to reuse in multiple designs; and (3) chiplets are less expensive to design.

Chiplets may have higher yield because they are smaller with fewer devices. However, a major drawback to chiplets compared to SoCs may be that use of chiplets generally requires far more chip-to-chip connections. Compared to the on-chip connections between functional blocks in SoCs, chip-to-chip connections may be typically much less dense and require far more power (for example normalized as energy per bit).

Though optics has been a candidate for chip-to-chip interconnects for decades, coupling optical sources and detectors to waveguides (including fibers) may frequently dominate the cost of optical links and limits their density for this application.

Optical interconnects based on microLED (μLED) sources may offer a way to overcome some or all of the limitations described herein. A microLED may be generally defined as an LED with an overall diameter/lateral dimension of <100 μm in some embodiments, <20 μm in some embodiments, <4 μm in some embodiments, and <1 μm in some embodiments. In some embodiments the μLED sources can support optical links with lengths of >1 m at >1 Gbps with lower drive power and very high density.

One aspect of practical realizations of a microLED link may be the way in which the microLED and photodetector (PD) arrays are coupled to the optical transmission medium that carries light between the transmitter and receiver ends of the link.

A parallel optical interconnect comprises a plurality of optical communication channels. In some embodiments, each communication channel comprises: an optical transmitter comprising a drive circuit that causes its input electrical signal to be modulated onto the optical output of an optical emitter (e.g. a microLED, LED or laser); input coupling optics that couple light from the emitter into a first (input) face of an optical transmission medium; an optical transmission medium; output coupling optics that couple light from a second (output) face of the optical transmission medium to an optical receiver; an optical receiver comprising photodetector (PD) coupling optics, a PD, and a receiver circuit that produces an output electrical signal. In some embodiments, the drive circuit of the optical transmitter may be integrated with an optoelectronic IC connected to the optical emitter, and the receiver circuit may be integrated with a second optoelectronic IC connected to the photodetector. In some embodiments, the photodetector may be monolithically integrated with the second optoelectronic IC.

In some embodiments of a parallel optical interconnect, the optical emitters are microLEDs made from direct gap semiconductors such as GaN/InGaN, InGaAlAs, InGaP, or InGaAsP. A parallel optical interconnect using microLED optical emitters may be referred herein as a microLED parallel optical interconnect. In some embodiments, the microLEDs are made from GaN/InGaN and emit light at wavelengths in the 400 nm-500 nm range. In some embodiments, the PDs are made from Si.

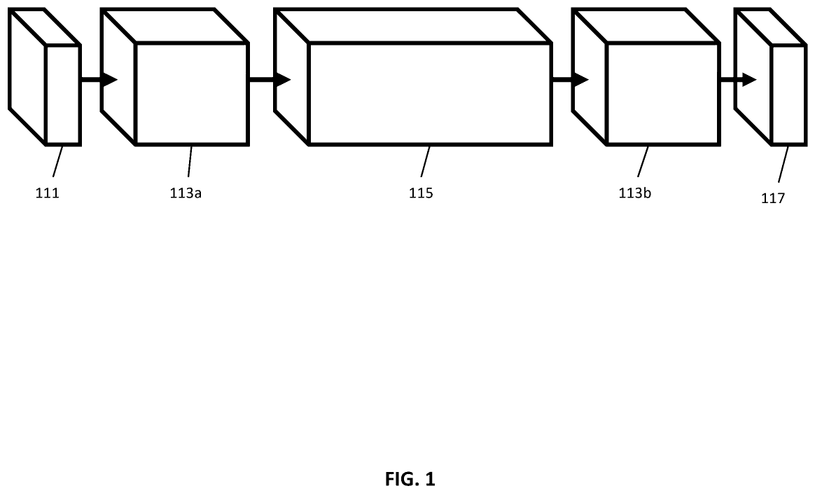

FIG. 1 is a block diagram of a parallel optical interconnect. In some embodiments, a parallel optical interconnect comprises an array of emitters 111, an input optical coupling assembly (OCA) 113a, a transmission medium 115, an output optical coupling assembly 113b, and an array of photodetectors (PDs) 117. In some embodiments, there are no input and output coupling optics, and the emitter and PD arrays are butt-coupled to the transmission medium. In the subsequent description, the term “optoelectronic device array” (or “OE device array”) may refer to an optical emitter array or a PD array.

In some embodiments, the array of emitters and the array of PDs are located on some regular grid. In some embodiments, the emitter and PD grids are hexagonal close-packed (HCP), square, or rectangular grids. In some embodiments, the center-to-center spacing of grid elements are in the range of 10 μm-100 μm.

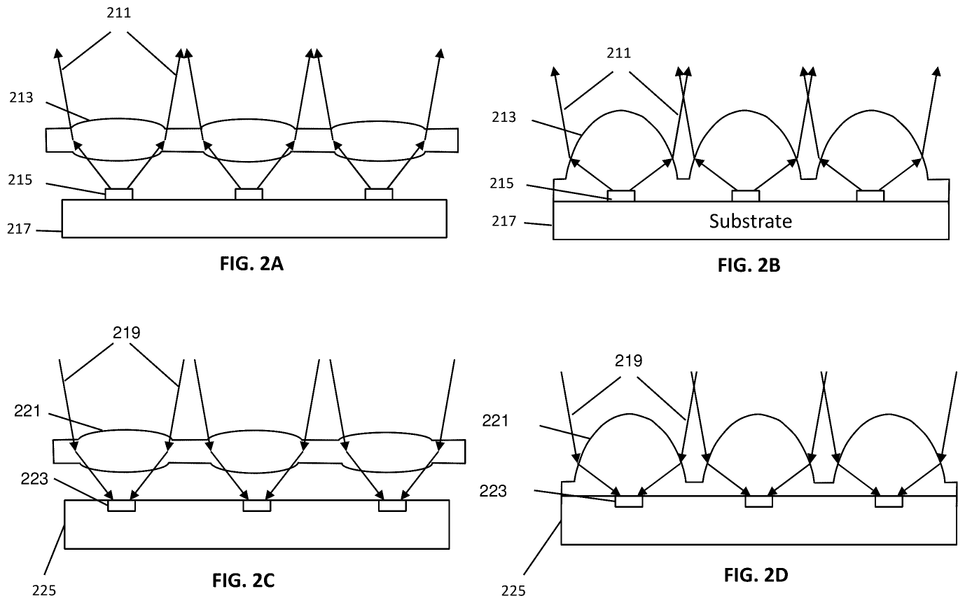

FIGS. 2A-D illustrate cross-sectional views of examples of microlenses to be interposed between optical emitters or photodetectors and an optical coupling assembly. As shown in FIGS. 2A-B, in some embodiments, a microlens 213, shown on a substrate 217, is interposed between each emitter 215 and the input optical coupling assembly (not shown in FIGS. 2A-B). The output angular optical distribution 211 from the microlens may be narrower than that from the emitter, which may reduce the required optical coupling assembly input diameter and coupling losses to the transmission medium. In some embodiments, a microlens 221 is interposed between the output optical coupling assembly (not shown in FIGS. 2C-D) and each PD 223, where each microlens focuses the light incident 219 on it onto its associated PD. In FIGS. 2C-D, the PDs are shown as within a substrate 225, in some embodiments the PDS may be on or effectively bonded to the substrate. In some embodiments, the microlenses are part of a microlens array that is positioned approximately one microlens focal length from the OE device array, for example as illustrated in FIGS. 2A, C. In some embodiments, the microlens array is attached to the OE device array such that the OE device array is embedded in a medium with a similar refractive index to the microlenses, for example as illustrated in FIGS. 2B, D.

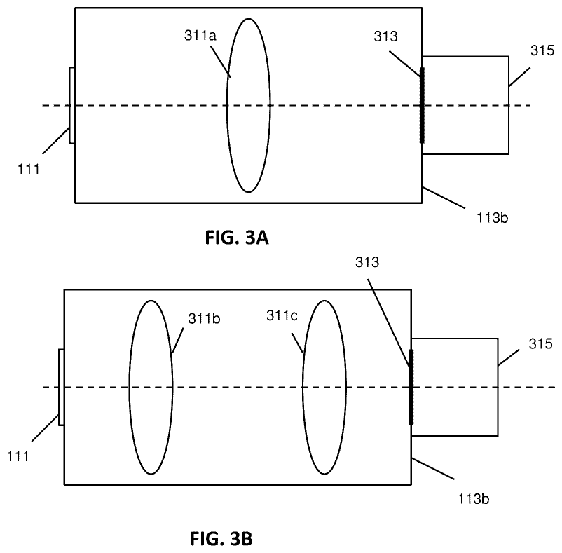

FIGS. 3A-B illustrate cross-sectional views of optical coupling assemblies including lenses. The optical coupling assemblies images light from an optical emitter array 111 onto an input face 313 of an optical transmission medium 315, or images light from the output face of an optical transmission medium onto a photodetector. In some embodiments, an optical coupling assembly for a parallel microLED interconnect comprises one or more lens elements where the lens focal lengths and distances between them are such that the OE element array is imaged onto the face of the transmission medium.

Some embodiments of an optical coupling assembly comprise one lens element 311a, for example as illustrated in FIG. 3A. In other embodiments, an optical coupling assembly comprises two lens elements 311b,c, for example as illustrated in FIG. 3B. In some embodiments the optical coupling assembly may comprise three or more lens elements. In some embodiments, one or more of the lens elements comprise aspheric surfaces.

An optical coupling assembly using lenses and/or mirrors to image light between an OE device array and a transmission medium may provide a number of significant benefits compared to butt-coupling the transmission medium directly to the OE device array, such as: (1) increased alignment tolerances between the OE device array and the transmission medium; (2) ability to turn an angle between the OE device array and the transmission medium, for instance a right angle; (3) variable magnification, which provides flexibility in optical design and potentially can increase connection density (channels per unit area); (4) ability to attach the fiber as a relatively late assembly step, providing more flexibility in the packaging process; and (5) ability to couple through transparent substrates or transparent package windows.

In some embodiments, the magnification of an optical coupling assembly is 1. In some embodiments, the magnification of the optical coupling assembly is greater than 1 while in some embodiments the magnification is less than 1. Varying the magnification of the optical coupling assembly allows the each of the OE device array grids and the transmission medium grid to be different, which provides flexibility in component design and fabrication, and can provide system design flexibility.

In some optical coupling assembly embodiments comprising one optical element with optical “power” (e.g. a lens or curved mirror), as shown in FIG. 3A, the distance from the OE device array to the optical element is 2f and the distance from the optical element to the transmission medium face is 2f, where f is the focal length of the optical element. This provides imaging with unity magnification.

In some embodiments of an optical coupling assembly comprising two optical elements with optical “power” (e.g. each optical element is a lens or curved mirror), as shown in FIG. 3B, the distance from the OE device array to the first optical element is f1, the distance from the first optical element to the second optical element is f1+f2, and the distance from the second optical element to the face of the transmission medium is f2, where f1 is the focal length of the first optical element and f2 is the focal length of the second optical element. Such spatial relation may image the OE device array onto the face of the transmission medium with a magnification of f2/f1. In some exemplary embodiments, f1=f2 and the magnification is unity.

In some embodiments of a parallel optical interconnect, the optical transmission medium for each channel comprises an optical waveguide, for instance an optical fiber or a planar optical waveguide. In some embodiments of a parallel optical interconnect, the transmission medium comprises an array of optical fibers (a fiber “bundle”) or an array of optical waveguides. In some embodiments, a fiber optic bundle (FOB) comprises multiple fiber elements (FEs) that are packed into a bundle, and comprises two optical “faces” at the two ends of the FOB where light is coupled into and out of the FOB. In some embodiments, each FE comprises a core surrounded by a concentric cladding layer with a lower index of refraction than the core, enabling the guiding of light in the core. In some embodiments, FEs in a FOB may be arranged in a regular pattern such as a square grid or a hexagonal grid. In some embodiments of a FOB, the positions of each FE relative to the other FEs are the same at each packing segment such that the FE positions are not “mixed” at each packing segment. An FOB in which the relative positions of the FEs are preserved is referred to as a “coherent” FOB. In some embodiments, the grid pattern of the FEs in a FOB matches that of the emitter array and PD array elements. In some embodiments, the FEs are on a finer grid than the emitter and PD array elements such that each emitter and PD couples to more than one FE in the FOB.

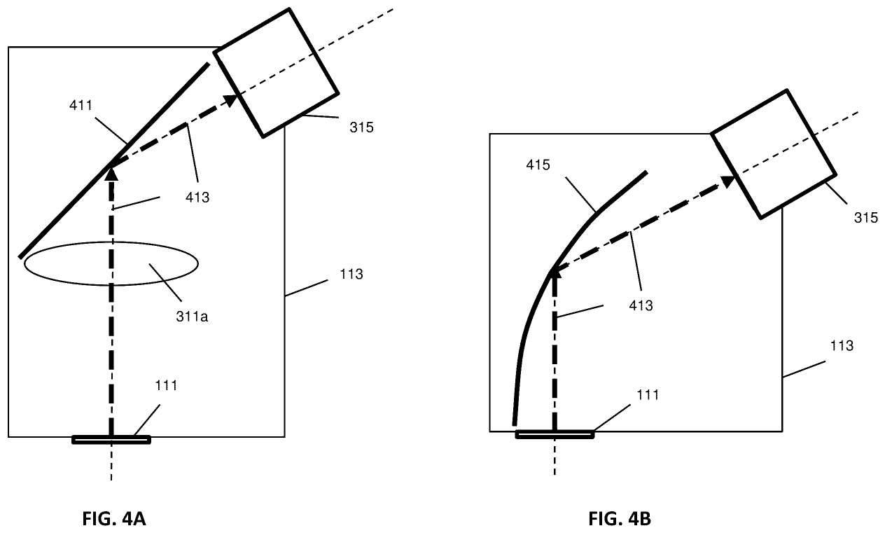

In some embodiments, the optical coupling assembly comprises one or more reflective surfaces. FIGS. 4A-B illustrate cross-sectional views of optical coupling assemblies including reflective surfaces. In some embodiments, the optical coupling assembly comprises some combination of lenses and reflective surfaces. Some of the reflective surfaces may be flat while others may be curved. Some embodiments of an optical coupling assembly 113 comprise one lens element 311a and one flat mirror 411 in an optical path 413 between an emitter array 111 (or PD array) and a face of a transmission medium 315, for example as shown in FIG. 4A. The mirror is positioned such that the optical path is turned at some angle between 0° and 90°, relative to the original incident optical path, and imaged onto the face of the transmission medium. As illustrated in FIG. 4B, some embodiments of an optical coupling assembly comprise one curved mirror 415, where the assembly is such that the optical path is turned by some angle between 0° and 90°, relative to the original incident optical path, and imaged onto a face of the transmission medium. In some exemplary embodiments, the optical path is turned by 90° relative to the original incident optical path.

In some embodiments, an optical coupling assembly comprises two separate optical coupling subassemblies (OCSAs). This may enable flexibility in the sequence in which the different parts are assembled, which can be very useful given, for instance, high processing temperatures used during certain assembly steps. In some embodiments, the optical design is such that the alignment tolerances between the two optical coupling subassemblies are large relative to the alignment tolerances between the elements within each optical subassembly. These large alignment tolerances may be desirable to improve manufacturing yield and decrease manufacturing costs.

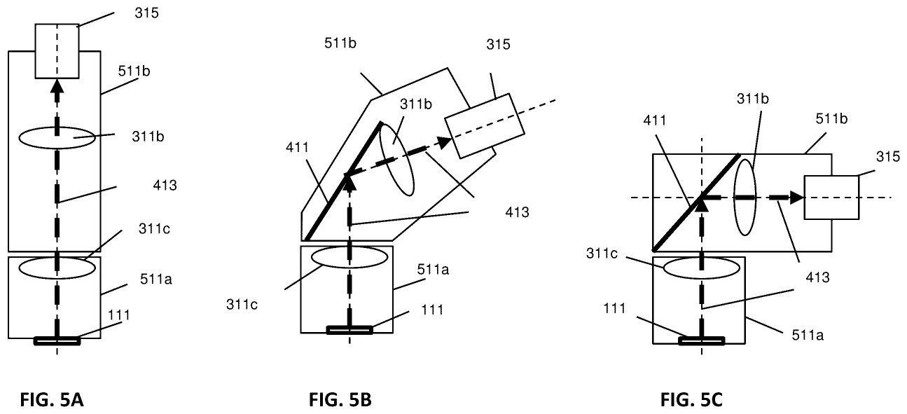

FIGS. 5A-C and 6A-B illustrate cross-sectional views of optical coupling assemblies including optical coupling subassemblies. In some embodiments of an optical coupling assembly comprising two optical coupling subassemblies, for example as illustrated in FIG. 5A, a first optical coupling subassembly 511a comprises a first lens 311c that couples to an OE device array 111 and a second optical coupling subassembly 511b comprises a second lens 311b that couples to a transmission medium 315, the first optical coupling subassembly being separate from the second optical coupling subassembly. The optical coupling assembly of FIG. 5A is therefore generally similar to the optical coupling assembly of FIG. 3B. In some embodiments, for example as illustrated in FIG. 5B a first optical coupling subassembly 511a comprises a first lens 311c that couples to an OE device array 111 and a second optical coupling subassembly 511b comprises a flat mirror 411 and a second lens 311b that couples to a transmission medium 315, where the mirror is between the first and the second lenses and the first optical coupling subassembly is separate from the second optical coupling subassembly. In some embodiments the flat mirror is at an angle relative to the optical path normal to the OE device array such that light is deflected through some angle less than 90°, relative to the original incident optical path from the OE device array, and towards the transmission medium. In some embodiments, for example as shown in FIG. 5C, the mirror is at 45° relative to the optical path normal to the OE device array such that light is deflected by an angle of 90°, relative to the original incident optical path from the OE device array, and towards the transmission medium. The optical coupling assemblies of FIGS. 5B-C are therefore somewhat generally similar to the optical coupling assembly of FIG. 4A.

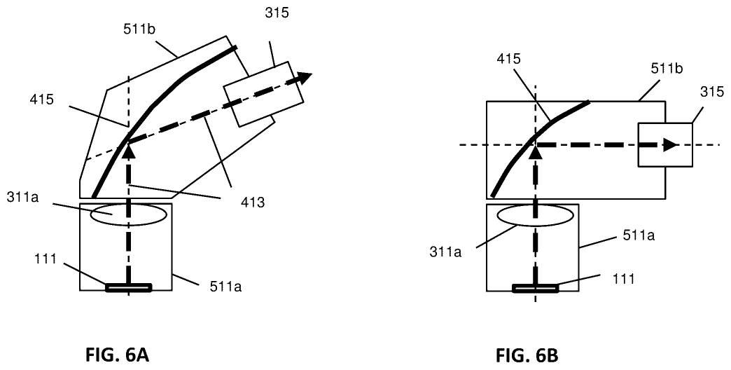

In some embodiments of an optical coupling assembly, for example as shown in FIG. 6A, a first optical coupling subassembly comprises a lens and a second optical coupling subassembly comprises a curved mirror 415 such that light is deflected by some angle less than 90°, relative to the original incident optical path from the OE device array, and towards the transmission medium. In some embodiments, for example as shown in FIG. 6B, the mirror is at 45° relative to the optical path normal to the OE device array such that light is deflected by an angle of 90°, relative to the original incident optical path from the OE device array, and towards the transmission medium. The optical coupling assemblies of FIGS. 6A-B are therefore somewhat generally similar to the optical coupling assembly of FIG. 4B.

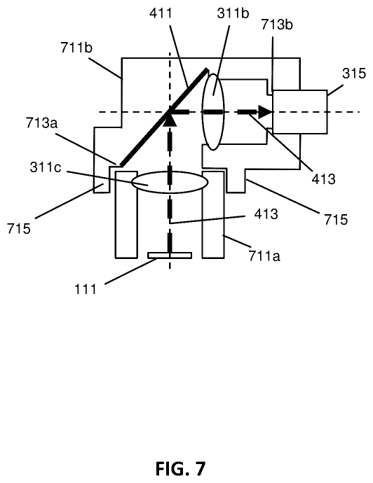

An optical coupling assembly typically also comprises one or more optomechanical structures, the purpose of which is to hold and accurately position the various optical elements relative to each other. FIG. 7 illustrates a cross-sectional view of an optical coupling assembly comprising separate optical components and optomechanical structures. In the example of FIG. 7, a first lens 311c of a first optomechanical structure 711a is in an optical path 413 between an OE array 111 and a transmission medium 315. The transmission medium is coupled to a second optomechanical structure 711b. The second optomechanical structure includes a flat mirror 411 and a second lens, both in the optical path between the OE array and the transmission medium (and between the first lens and the transmission medium. In some embodiments of an optical coupling assembly, a subassembly or assembly comprising one or more optical elements comprises separate optical components and optomechanical structures. In some embodiments, each lens may comprise a glass or plastic that is inserted into an opto-mechanical structure that holds and positions each optical element with high positional accuracy. The opto-mechanical structure may comprise one of more parts, where each part may, for instance, be made from plastic, metal, or micromachined silicon.

In some embodiments of an optical coupling assembly, a subassembly or assembly comprising one or more optical elements (e.g. lenses and/or mirrors) comprises a single block of a single material (e.g. molded plastic) with both optical and optomechanical functionality. In some embodiments, the surfaces of reflective elements, which may be formed inside the opto-mechanical structure, may comprise reflective coatings and the surfaces of refractive elements, which may be inside the optomechanical structure, may comprise anti-reflective (AR) coatings.

In some embodiments, the optomechanical structures also comprise features that enable the optical coupling assembly to be accurately positioned relative to the OE device array, the transmission medium, and to other optomechanical structures. Such features may be mechanical keying features or may be fiducial features that allow, for instance, a machine vision system or human operator to accurately position the optical coupling assembly. In some embodiments, one of the optomechanical structures being part of an optical coupling subassembly may have a one or more connecting recesses, e.g., recess 713a for connecting and receiving another optomechanical structure being part of another optical coupling subassembly. In some embodiments, and as shown in FIG. 7, one of the optomechanical structures may have one or more structural protrusions 715 proximate to the one or more recesses for covering the connecting portion of the other optomechanical structure and further securing the other optomechanical structure to the one of the optomechanical structures. In some embodiments, the optomechanical structures comprise features allowing the optical coupling assembly to be attached to other components such as substrates, the optical transmission medium, or other mechanical components such as a package housing. In some embodiments, the second optomechanical structure may have one or more second recesses 713b for connecting and receiving the optical transmission medium.

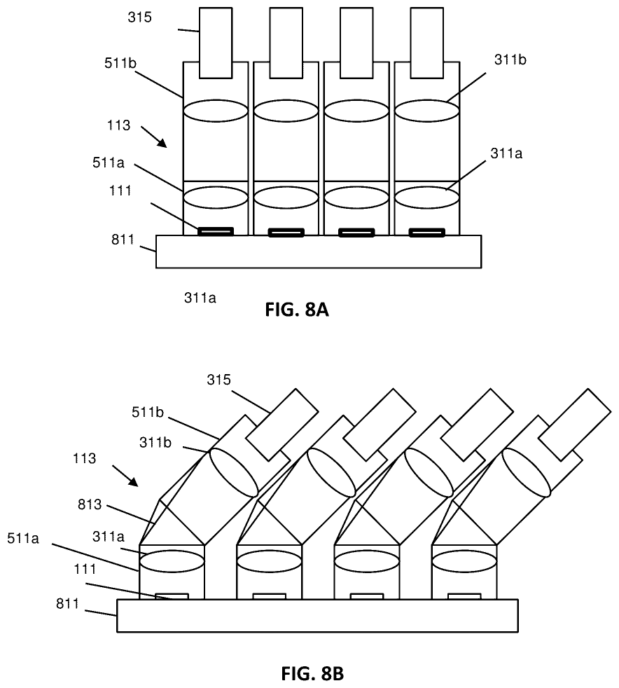

In some embodiments, one or more parallel optical interconnects may be interfaced to the surface of an IC. Each of these parallel optical interconnect interfaces comprise an OE device array, an optical coupling assembly that may have one or more optical coupling subassemblies, and a transmission medium. FIGS. 8A-B illustrate cross-sectional views of arrays of optical coupling assemblies interfaced to an IC. In some embodiments, each optical coupling assembly 113 is comprised of two or more optical coupling subassemblies 511a,b. In some embodiments, and as illustrated in FIG. 8A, the optical coupling assembly comprises a straight optical path in the one or more optical coupling subassemblies that are normal to a surface of an IC 811 and normal to an OE device array 111, for example as generally discussed with respect to FIG. 5A. As shown in FIG. 8A, the plurality of OE device arrays are on a surface of the IC, with each having an associated optical coupling assembly. Each optical coupling assembly includes about the OE device array a first optical coupling subassembly with a lens 311a. A second optical coupling subassembly with a further lens 311b is on an end of the first optical coupling subassembly, distal from the OE device, with a transmission medium 315 at a far end of the second optical coupling subassembly.

In some embodiments, the optical coupling assembly comprises an optical path bent through some angle between 0° and 90° using one or more reflective surfaces in the optical coupling subassemblies, for example as generally discussed with respect to FIGS. 5B-C and 6A-B. An array of optical coupling assemblies, each with a bent optical path and two optical coupling subassemblies 511a,b, is shown in FIG. 8B. The first optical coupling subassembly may include a lens 311a. the second optical coupling subassembly may extend from the first optical coupling assembly, at an end distal from the OE device array 111, at an angle, for example as shown in FIG. 8B. The second optical coupling assembly may include a reflective surface 813, for example a mirror, to change direction of the optical path between the OE device array and the transmission medium 315 at the far end of the second optical coupling assembly. A further lens 311b may also be optically between the reflective surface and the transmission medium.

For a straight optical path, the optical coupling assemblies may be designed such that they can be placed close to each other, which enables a high connection density (in channels per unit area). For the bent optical path, the optical coupling assemblies may be placed next to each other but the maximum achievable density may be reduced by mechanical interference constraints, but lower acute bending angles (e.g., 0° to 45°) between the optical coupling subassemblies of an assembly may typically enable higher connection densities. In some embodiments, parallel optical interconnect interfaces are arranged in a linear array while in some embodiments they are arranged in a two-dimensional array.

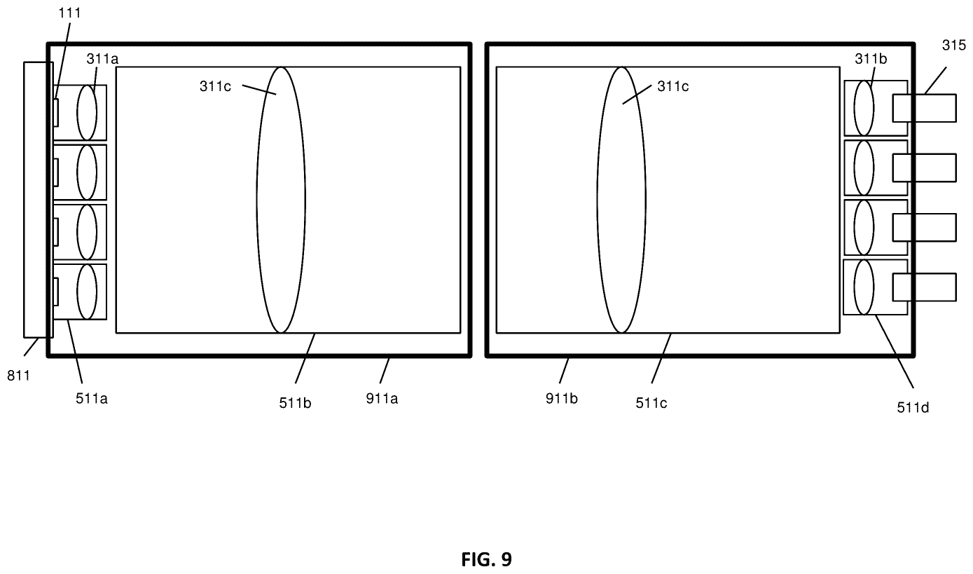

In some embodiments of an optical coupling assembly, the optical coupling assembly is comprised of four optical coupling subassembly (OCSA) stages, which each stage/section may have its own optical components and optomechanical structures. FIG. 9 illustrates a cross-sectional view of an optical coupling assembly comprised of four optical coupling subassembly (OCSA) stages. In FIG. 9, arrays of OE devices 111 are on a surface of an IC 811. For each array of OE devices, a Stage 1 optical coupling subassembly 511a optically couples light between the array and further stages. Similarly for each transmission medium 315, a Stage 4 optical coupling subassembly 511d couples light between the further stages and the transmission medium In some embodiments, Stage 1 511a and Stage 4 511d each comprise an array of optical coupling subassemblies similar to others described herein, where a Stage 1 optical coupling subassembly is coupled to Stage 4 optical coupling subassembly and may transmit light and image between the OE device arrays and the face of the optical transmission mediums. FIG. 9 shows a Stage 2 optical coupling subassembly 511b and a Stage 3 optical coupling subassembly 511c in optically in series between the Stage 1 and Stage 4 optical coupling subassemblies. In some embodiments Stage 2 and Stage 3 optical coupling subassemblies 511b,c comprise larger lenses, for example lenses 311c, and/or mirrors (e.g., two to five times larger than Stage 1 and 4 lenses and/or mirrors) such that a Stage 2 optical coupling subassembly and Stage 3 optical coupling subassembly are interposed between Stage 1 and Stage 4 optical coupling subassemblies. As such, light and images may be coupled from multiple arrays of OE device arrays connected to the Stage 1 optical coupling subassemblies and onto multiple arrays of Stage 4 optical coupling subassemblies onto the transmission mediums. In some embodiments, the lenses and mirrors used in each Stage 2 and 3 of the optical coupling subassemblies may be fewer than the lenses and mirrors used in each Stage 1 and 4 of the optical coupling subassemblies. In some further embodiments, a first composite optical coupling subassembly (Composite OCSA A) 911a comprises the array of Stage 1 optical coupling subassemblies and a Stage 2 optical coupling subassembly, and a second composite optical coupling subassembly (Composite OCSA B) 911b, which is a separate component from composite OCSA A, comprises a Stage 3 optical coupling subassembly and an array of Stage 4optical coupling subassemblies. Compared to other optical coupling assembly architectures described herein, the use of larger lenses in Stages 2 and 3 may allow for larger distances between the OE device arrays and the transmission medium and allow larger alignment tolerances, increasing packaging flexibility.

Although the invention has been discussed with respect to various embodiments, it should be recognized that the invention comprises the novel and non-obvious claims supported by this disclosure.

What is claimed is:

1. A microLED-based optical interconnect including an optical coupling assembly, comprising:
a first array of optoelectronic devices on an integrated circuit (IC);
a first fiber optic bundle comprised of multiple fiber elements, with a first face for coupling light into or out of the fiber elements at a first end of the first fiber optic bundle and a second face for coupling light into or out of the fiber elements at a second end of the first fiber optic bundle;
a first optical coupling subassembly on the IC, the first optical coupling assembly including at least one first optical element positioned in an optical path of light between the first array of optoelectronic devices and the first face of the first fiber optic bundle; and
a second optical coupling subassembly coupled to an end of the first optical coupling subassembly distal from the IC and coupled to the fiber optic bundle, the second optical subassembly including at least one second optical element positioned in the optical path of light between the first array of optoelectronic devices and the first face of the first fiber optic bundle;
with the first optical coupling subassembly and/or the second optical coupling subassembly including at least one recess for receiving the other of the first and/or second optical coupling subassembly.

2. The microLED-based optical interconnect including an optical coupling assembly of claim 1, wherein the first array of optoelectronic devices comprises an array of microLEDs.

3. The microLED-based optical interconnect including an optical coupling assembly of claim 1, wherein the first array of optoelectronic devices comprises an array of photodetectors.

4. The microLED-based optical interconnect including an optical coupling assembly of claim 1, wherein the at least one first optical element comprises a first lens.

5. The microLED-based optical interconnect including an optical coupling assembly of claim 4, wherein the at least one second optical element comprises a second lens.

6. The microLED-based optical interconnect including an optical coupling assembly of claim 4, wherein the at least one second optical element comprises a first mirror and second lens.

7. The microLED-based optical interconnect including an optical coupling assembly of claim 1, wherein the second optical coupling subassembly further includes a recess for receiving the first fiber optic bundle.

8. The microLED-based optical interconnect including an optical coupling assembly of claim 1, further comprising:
a second array of optoelectronic devices on the integrated circuit (IC);
a second fiber optic bundle comprised of multiple fiber elements, with a first face for coupling light into or out of the fiber elements at a first end of the second fiber optic bundle and a second face for coupling light into or out of the fiber elements at a second end of the second fiber optic bundle;
a third optical coupling subassembly on the IC, the third optical coupling assembly including at least one third optical element positioned in an optical path of light between the second array of optoelectronic devices and the first face of the second fiber optic bundle; and
a fourth optical coupling subassembly coupled to an end of the third optical coupling subassembly distal from the IC and coupled to the second fiber optic bundle, the fourth optical subassembly including at least one fourth optical element positioned in the optical path of light between the second array of optoelectronic devices and the first face of the second fiber optic bundle;
with the third optical coupling subassembly and/or the fourth optical coupling subassembly including at least one recess for receiving the other of the third and/or fourth optical coupling subassembly.

9. The microLED-based optical interconnect including an optical coupling assembly of claim 8, wherein the first array of optoelectronic devices comprises an array of microLEDs and the second array of optoelectronic devices comprises an array of photodetectors.

10. The microLED-based optical interconnect including an optical coupling assembly of claim 9, wherein the at least one third optical element comprises a third lens.

11. The microLED-based optical interconnect including an optical coupling assembly of claim 10, wherein the at least one fourth optical element comprises a fourth lens.

12. The microLED-based optical interconnect including an optical coupling assembly of claim 10, wherein the at least one fourth optical element comprises a second mirror and fourth lens.

13. The microLED-based optical interconnect including an optical coupling assembly of claim 8, wherein the fourth optical coupling subassembly further includes a recess for receiving the second fiber optic bundle.
